(19) United States
(12) Patent Application Publication
(10) Pub. No.: US 2022/0234840 A1
(43) Pub. Date: Jul. 28, 2022

(54) SORTING DEVICE

(71) Applicant: BEIJING KUANGSHI ROBOTICS TECHNOLOGY CO., LTD., Beijing (CN)

(72) Inventors: Deping CHEN, Beijing (CN); Yupei WANG, Beijing (CN)

(21) Appl. No.: 17/611,964

(22) PCT Filed: Aug. 28, 2019
(86) PCT No.: PCT/CN2019/103040

§ 371 Date: Nov. 17, 2021

(30) Foreign Application Priority Data
Jun. 17, 2019 (CN) 201910523817.X
Aug. 9, 2019 (CN) 201910738918.9

(51) Int. Cl. B65G 47/46; B07C 3/08; B65G 37/02

(52) U.S. Cl. CPC B65G 47/46; B65G 37/02; B07C 3/08

(57) ABSTRACT

A sorting device comprises a sorting apparatus moving along a predetermined path and a container conveyer located below the sorting apparatus. The sorting apparatus comprises a plurality of sorting stations arranged in a predetermined path, wherein a first discharge port and a second discharge port are formed on two sides of each sorting station along the predetermined path, respectively. A plurality of containers is placed on the container conveyer and is arranged in a linear array. The direction of the linear array is the direction of the connecting line of the first discharge port and the second discharge port where the containers reciprocate, so that two of the plurality of containers are aligned with the first discharge port and the second discharge port.

### CROSS-REFERENCE TO RELATED APPLICATIONS

This application claims the priority of the Chinese patent application No. 201910738918.9 filed on Aug. 9, 2019 and the Chinese patent application No. 201910523817.X filed on Jun. 17, 2019, the contents of which are incorporated herein by reference as a part of the application.

### TECHNICAL FIELD

Embodiments of the present disclosure relates to a sorting device.

### BACKGROUND ART

At present, with rapid development of the logistics and transportation industry, goods handled in warehouses of various courier companies has also increased sharply in number.

In order to relieve the pressure of sorting and transportation goods and improve delivering efficiency, some sorting devices have gone into a distribution center, such as: a cross-belt sorter, a tilt-tray sorter, a slider sorter, a split sorter, a baffle sorter. Some sorting devices have also gone into an e-commerce warehouse, such as a tilting tray sorting device.

The known sorting devices have a complex overall structure, inconvenient operation and maintenance by operators, low sorting efficiency, and high operation and management cost.

### SUMMARY

In view of the above, an embodiment of the present disclosure provides a sorting device for solving problems of low sorting efficiency and high operation and management cost of the sorting device in the prior art.

An embodiment of the disclosure provides a sorting device, comprising a sorting apparatus configured for moving along a predetermined path and a container delivering apparatus located beneath said sorting apparatus;

said sorting apparatus comprises a plurality of sorting stations that are provided along said predetermined path, wherein each sorting station is provided with a first discharge port and a second discharge port on two sides of said predetermined path, respectively;

a plurality of containers arranged in a linear array are placed on said container delivering apparatus, the direction of said linear array is a direction of a connecting line of said first discharge port and said second discharge port, and the plurality of containers on said container delivering apparatus can reciprocate in the direction of the connecting line of said first discharge port and said second discharge port, such that two of said plurality of containers are aligned with said first discharge port and said second discharge port.

The sorting device provided by the embodiment of the disclosure comprises a sorting apparatus movable along a predetermined path and a container delivering apparatus located beneath said sorting apparatus, wherein a plurality of sorting stations are provided along the predetermined path, each sorting station is provided with two discharge ports, a plurality of containers are placed on the container delivering apparatus, and the plurality of containers on the container delivering apparatus can reciprocate in the direction of the connecting line of the first discharge port and the second discharge port such that two of the plurality of containers are aligned with the first discharge port and the second discharge port. Therefore, through the cooperation of the two discharge ports with the plurality of containers, it can improve sorting efficiency and help to reduce operation and management cost.

The above description is only an overview of the technical solution of the present disclosure. In order to understand the technical means of the present disclosure more clearly and implement them in accordance with the content of the specification, and to make the above and other objectives, features, and advantages of the present disclosure more comprehensible, specific implementations of the present disclosure are described below.

### BRIEF DESCRIPTION OF DRAWINGS

By reading the detailed description of some embodiments below, various other advantages and benefits will be made clear to those of ordinary skill in the art. The drawings are used only for purposes of showing some embodiments and are not considered a limitation on the present disclosure. Also throughout the drawings, the same component is represented with the same reference numeral. In the attached drawing:

FIG. 1 is a three-dimensional schematic diagram of a sorting device provided in an embodiment of the present disclosure;

FIG. 2 is a top view of the structural arrangement of the sorting device provided in the embodiment of the present disclosure;

FIG. 3 is a schematic diagram of a container conveying apparatus of the sorting device provided in the embodiment of the present disclosure;

FIG. 4 is a layout diagram of a container conveyor of the sorting device provided in the embodiment of the present disclosure;

FIG. 5 is a structural schematic diagram of the container conveyor of the sorting device provided in the embodiment of the present disclosure;

FIG. 6 is a structural schematic diagram of a rotary circular table of the sorting device provided in the embodiment of the present disclosure;

FIG. 7 is a structural schematic diagram of a sorting apparatus of the sorting device provided in the embodiment of the present disclosure;

FIG. 8 is a structural schematic diagram of a sliding chute of the sorting device provided in the embodiment of the present disclosure; and

FIG. 9 is a structural schematic diagram of a bearing bracket of the sorting device provided in the embodiment of the present disclosure.

### DETAILED DESCRIPTION OF EMBODIMENTS

The exemplary embodiments of the present disclosure will be described in more detail below with reference to the accompanying drawings. Although exemplary embodiments of the present disclosure are shown in the accompanying drawings, it should be understood that the present disclosure may be implemented in various forms and not limited by the embodiments illustrated herein. Instead, these embodiments are provided to enable a more thorough understanding of the present disclosure and to convey the scope of the disclosure fully to those skilled in the art.

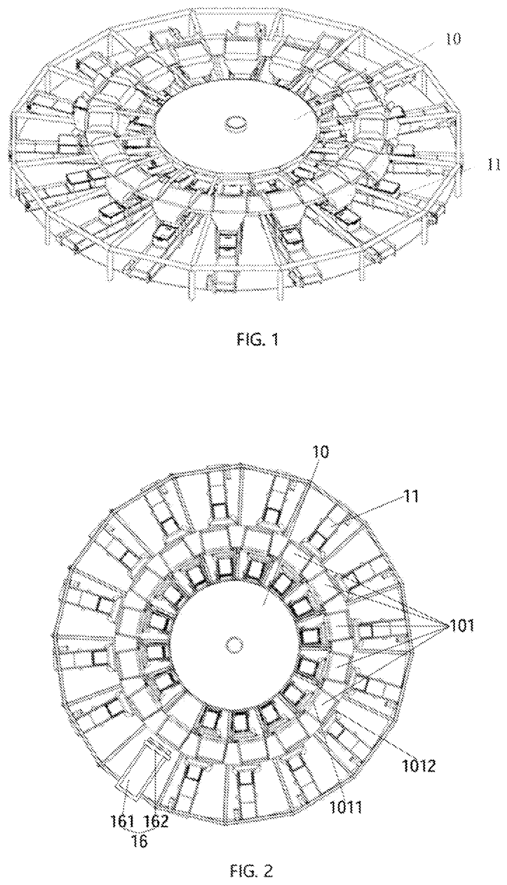

Referring to FIGS. 1 and 2, an embodiment of the present disclosure provides a sorting device comprising a sorting apparatus 10 movable along a predetermined path and a container delivering apparatus 11 located beneath said sorting apparatus 10;

said sorting apparatus 10 comprises a plurality of sorting stations 101, wherein the plurality of sorting stations 101 are provided along said predetermined path, and each sorting station 101 is provided with a first discharge port 1011 and a second discharge port 1012 on two sides of said predetermined path, respectively; and

a plurality of containers arranged in a linear array are placed on said container delivering apparatus 11, the direction of said linear array is a direction of a connecting line of said first discharge port 1011 and said second discharge port 1012, and the plurality of containers on said container delivering apparatus 11 can reciprocate in the direction of the connecting line of said first discharge port 1011 and said second discharge port 1012, such that two of said plurality of containers are aligned with said first discharge port 1011 and said second discharge port 1012.

Specifically, as shown in FIGS. 1 and 2, a sorting device provided in an embodiment of the present disclosure comprises a sorting apparatus 10 movable along a predetermined path and a container delivering apparatus 11 located beneath the sorting apparatus 10. The sorting apparatus 10 is used to classify and sort out the received goods in accordance with a preset classification rule, wherein the predetermined path is a path determined by the structure and profile of the sorting apparatus 10, for example, a straight line, a curve, or even a closed ring. The container delivering apparatus 11 is located beneath the sorting apparatus 10, and can collect and store goods belonging to various lists or categories, through the containers on the container delivering apparatus 11.

The sorting apparatus 10 sorts goods belonging to the same list (e.g. order) into one or more containers, has a high sorting efficiency, and can solve the demand of sorting massive goods according to the list. The sorting apparatus 10 may be in an open linear structure with a linear shape or a curved shape, which is provided with a starting point and an end point, such as an L-shaped, U-shaped, or linear structure. Of course, the sorting apparatus 10 can also be a closed rotary cycle structure, that is, the beginning point and end point of the rotary cycle structure are connected together, making the sorting apparatus 10 be in a closed loop, for example, a circular rotary cycle structure, a rectangular rotary cycle structure or a rotary cycle structure in an irregular shape designed according to a device installation site. Compared with the open linear structure, the closed rotary cycle structure can sort goods continuously and cyclically, and maintain continuous movement to avoid parking of goods, thus improving sorting efficiency and saving device installation space.

Taking the rotary cycle structure as an example, a plurality of sorting stations 101 are distributed along a rotary cycle path of the sorting apparatus 10. Each sorting station 101 is provided with a first discharge port 1011 and a second discharge port 1012 on two sides along the rotary cycle path respectively, and a plurality of containers are placed on the container delivering apparatus 11, and arranged in a linear array whose direction is a direction of connecting line of the first discharge port 1011 and the second discharge port 1012, and can reciprocate in the direction of the connecting line of the first discharge port 1011 and the second discharge port 1012, so that two containers of the plurality of containers are aligned with the first discharge port 1011 and the second discharge port 1012. For example, on the container delivering apparatus 11, eight containers are arranged, numbered from first to eighth, wherein through the movement of the container delivering apparatus 11, the first container can be controlled to be aligned with the first discharge port 1011 so as to collect the goods sorted out from the first discharge port 1011, and the third container can be controlled to be aligned with the second discharge port 1012 so as to collect the goods sorted out from the second discharge port 1012. Of course, in a practical application, it may be determined according to a control strategy that any two of the plurality of containers are aligned with the first discharge port 1011 and the second port 1012, which is not constrained in the present disclosure.

It should be noted that the above container has a certain cavity and an opening that can be used for receiving the goods, and may be a case, box or a bag product made of a metal or non-metallic material, for example, a wooden box, a woven bag, etc.

Therefore, in the embodiment of the present disclosure, after the goods reach the sorting station 101 of the sorting apparatus 10, with the rotary movement of the sorting apparatus 10, the sorting station 101 can circularly move according to a sorting rule, and deliver the goods to a corresponding container on the container delivering apparatus 11 through the first discharge port 1011 or the second discharge port 1012 of the sorting station 101. Thus, by switching the sorting station 101, it can make the two discharge ports on the sorting station 101 cooperate with multiple containers for sorting, thus greatly improving the sorting efficiency of goods.

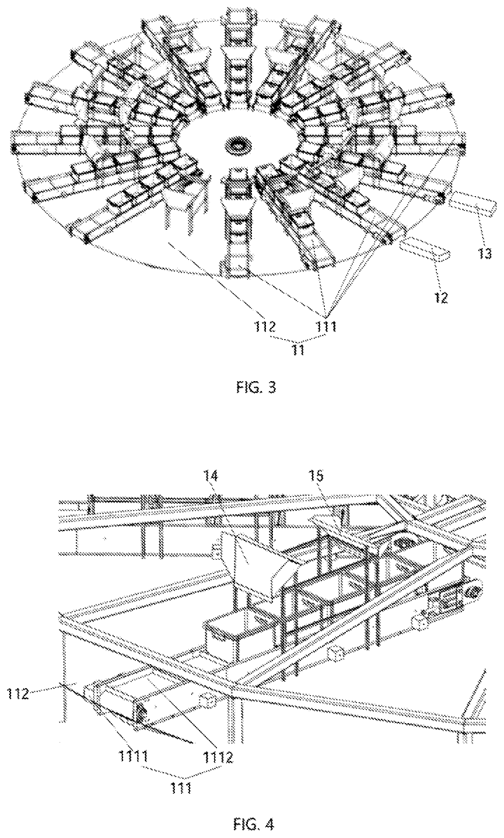

Optionally, referring to FIG. 3, said container delivering apparatus 11 comprises container conveyors 111 and a rotary mechanism 112;

said container conveyors 111 are fixedly connected to the rotary mechanism 112, and said container conveyors 111 rotate with the rotary mechanism 112. In some examples, the rotary path of said rotary mechanism 112 may be consistent with the rotary cycle path of said sorting apparatus 10; and

said plurality of containers are placed on said container conveyor 111, and said rotating mechanism 112 drives the container conveyor 111 to rotate.

Specifically, as shown in FIG. 3, the aforementioned container delivering apparatus 11 comprises container conveyors 111 and a rotary mechanism 112. The container conveyors 111 are fixedly connected to the rotary mechanism 112, and in some examples, the rotary mechanism 112 has a rotary path which is consistent with that of the sorting apparatus 10, so that when the rotary mechanism 112 beneath the sorting apparatus10 moves along the rotary cycle path, the container conveyor 111 is driven to rotate, wherein since the plurality of containers are placed on the container conveyor 111, it can be realized that the container is aligned with the first discharge port 1011 or the second discharge port 1012 on the sorting station 101. In other embodiments, while the sorting station 101 of the sorting apparatus 10 is rotated, the container delivering apparatus 11 can also rotate, which can shorten the time required to align the sorting station 101 with the corresponding container and improve the sorting efficiency, and at the same time, the rotation of the container delivering apparatus 11 can also realize the circulation of the container, helping to shorten the time for case replacing during the sorting process. It is understood that the above container conveyor 111 may be an automated conveying machine, or a conveying trolley which can be driven by mechanical power or rely on human power, which is not limited in the embodiments of the present disclosure.

Optionally, referring to FIGS. 4 and 5, said container conveyor 111 comprises a reciprocating delivery mechanism 1111 and a container carry platform 1112; and

a plurality of containers is placed on said container carry platform 1112, the reciprocating delivery mechanism 1111 is fixedly connected to said rotary mechanism 112, and said container carry platform 1112 linearly reciprocates with said reciprocating delivery mechanism 1111.

Specifically, as shown in FIGS. 4 and 5, the aforementioned container conveyor 111 comprises a reciprocating delivery mechanism 1111 and a container carry platform 1112. The reciprocating delivery mechanism 1111 is capable of performing linear reciprocal motion, the container carry platform 1112 is mounted with the reciprocating delivery mechanism 1111, and the reciprocating delivery mechanism 1111 provides power for reciprocal movement of the container carry platform 1112 to make containers placed on the container carry platform 1112 reciprocate linearly so as to be aligned with the first discharge port 1011 or second discharge port 1012 on the sorting station 101. Meanwhile, with the fixed connection between the reciprocating delivery mechanism 1111 and the rotary mechanism 112, the rotation of the rotary mechanism 112 can also drive the rotation of the reciprocating delivery mechanism 1111, i. e., the rotation of the container carry platform 1112 and the container.

Optionally, a surface of the container carry platform 1112, on which the plurality of containers are placed, is provided with a plurality of limiting elements for limiting the translation (translational displacement) of the containers in the first and/or second direction, wherein the first direction is the moving direction of the container carry platform 1112, and the second direction is perpendicular to the first direction.

Specifically, in order to avoid the plurality of containers on the container carry platform 1112 sliding due to external force or inertia generated movement when moving with the container carry platform 1112, the limiting elements can be provided in the rectilinear motion direction of the container carry platform 1112 and constrain the sliding of the containers in that direction. For example, a plurality of partition plates 11121 may be provided on the container carry platform 1112 (i.e., the container carry platform 112 may be specifically implemented as a conveying belt with the partition plates 11121 as shown in FIG. 5), or protrusions may be provided on one side or two sides of the container carry platform 1112, so as to restrict the movement of the container in the rectilinear motion direction of the container carry platform 1112. The spacing between adjacent partition plates or protrusions depends on the size of the container.

Optionally, the limiting elements may be provided on two sides of a direction perpendicular to the rectilinear motion direction of the container carry platform 1112, that is, two sides of the direction of connecting line of the first discharge port and the second discharge port, so as to prevent lateral sliding and tip-over of the container and ensure structural safety of the container.

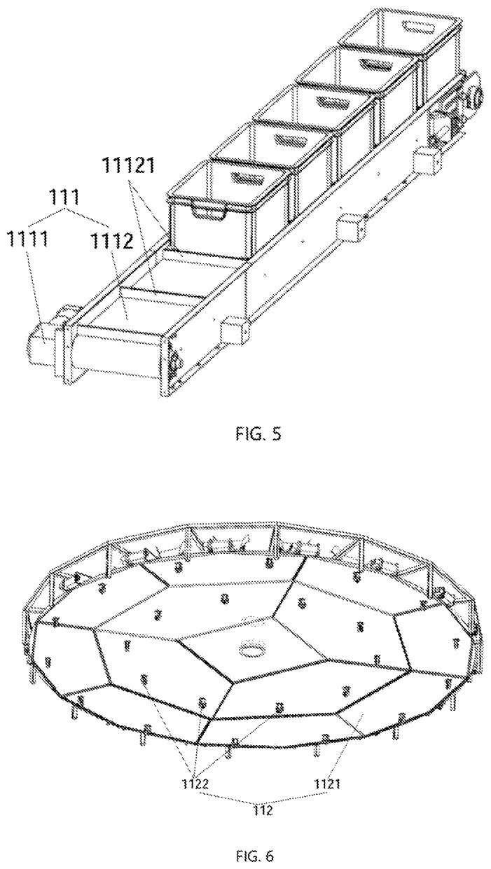

Optionally, referring to FIG. 6, said rotary mechanism 112 comprises a rotating chassis 1121 and universal wheels 1122;

said container conveyors 111 are fixed to one side of said rotating chassis 1121 away from the ground, and said universal wheels 1122 are fixed to one side of said rotating chassis 1121 close to the ground.

Specifically, as shown in FIG. 6, the aforementioned rotary mechanism may be in a disk structure, comprising a rotating chassis 1121 and universal wheels 1122. The container conveyors 111 are fixed to one side of the rotating chassis 1121 away from the ground, and the universal wheels 1122 are fixed to one side of the rotating chassis 1121 close to the ground. Therefore, under the support of the universal wheels 1122, the rotating chassis 1121 can drive the rotation of the container conveyor 111 as the universal wheels 1122 rolls, to facilitate the circulation and replacement of the containers.

Optionally, said rotary mechanism 112 comprises a circular rail;

the bottom of said container conveyor 111 is slidably connected to said circular rail.

Specifically, as another implementation of the rotary mechanism 112, the aforementioned rotary mechanism 112 may comprise a circular rail, there may be one, two or more circles of circular rail and the circular rail may be provided on the ground. In the case of one circle, the rail can be provided along the middle of the rotary path of the container conveyor 111. In the case of two circles of the rails the rails can be provided in parallel along the inside and outside of the rotary path of the container conveyor 111. In the case of three circles of the rails, the rails can be evenly distributed and provided in parallel between the inside and outside of the rotary path of the container conveyor 111. The bottom of the container conveyor 111 may be slidably connected to the circular rail, and of course, in order to reduce resistance, they can also in rolling connection with each other by using rolling wheels.

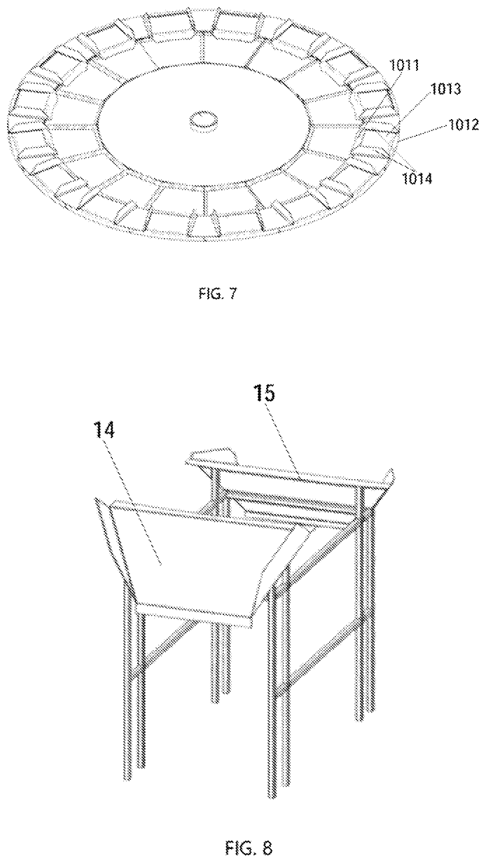

Optionally, referring to FIG. 7, each sorting station 101 is provided thereon with a sorting-delivering assembly 1013, with the sorting-delivering assembly 1013 capable of moving towards said first discharge port 1011 or said second discharge port 1012.

Specifically, as shown in FIG. 7, the aforementioned sorting station 101 is provided with a sorting-delivering assembly 1013 thereon which can move in two directions under the control of a control system. When the sorting-delivering assembly 1013 is moved to the first discharge port 1011, goods on the sorting station 101 may be delivered out from the first discharge port 1011. When the sorting-delivering assembly 1013 is moved to the second discharge port 1012, the goods on the sorting station 101 may be delivered out from the second discharge port 1012. With the sorting-delivering assembly 1013 capable of moving in two directions, it may automatically select a discharge port for delivering goods.

Specifically, the above sorting-delivering assembly may be any one of a conveying belt without a partition plate, a conveying belt with partition plates, a conveying roller, a tilting tray and a tilting bucket. When the conveying belt with partition plates is adopted, since the conveying belt is provided with the partition plate structure, it can avoid the movement of goods caused by inertia when the goods are delivered to the discharge port. When the sorting-delivering assembly is embodied as the conveying belt without a partition plate, the conveying belt with partition plates or the conveying roller, the conveying belt without a partition plate, the conveying belt with partition plates or the conveying roller may rotate towards the discharge ports at the two sides so that the goods thereon are delivered to the corresponding container via the first discharge port or second discharge port. When the sorting-delivering assembly is embodied as the tilting tray or the tilting bucket, the tilting tray or tilting bucket may tilt towards the first or second discharge port so that the goods thereon slide into the corresponding container via the first discharge port or second discharge port. It is understood that the delivery assemblies in various different forms of structure expand the selectable range of the technicians and help to improve the actual application range of the device. In a practical application, technicians may flexibly select a suitable delivery assembly according to the actual structural needs, which is not constrained by the embodiments of the present disclosure.

Optionally, referring to FIG. 7, said each sorting station 101 is provided thereon with side baffles 1014, wherein the side baffles 1014 are located between said first discharge port 1011 and said second discharge port 1012 and provided along two sides of the discharge direction.

Specifically, as shown in FIG. 7, in order to avoid accidental slipping of the goods from the sorting station 101, side baffles 1014 are provided between the first discharge port 1011 and the second discharge port 1012, along two sides of the discharge direction. When the goods are placed on the sorting station 101, if they are bounced to an edge of the sorting station 101, they may be constrained by the side baffle 1014 to prevent falling.

Optionally, referring to FIG. 3, said sorting device further comprises a first delivery assembly 12;

said first delivery assembly 12 is aligned with one of said plurality of container conveyors 111, the first delivery assembly 12 can move in a direction close to or away from said container conveyor 111, for introducing a preset number of idle containers into said container conveyors 111, and/or removing to-be-replaced container(s) from said container conveyors 111.

Specifically, as shown in FIG. 3, the aforementioned sorting device further comprises a first delivery assembly 12. The installation position of the first delivery assembly 12 may be determined by on-site assembly personnel according to the actual layout of an installation site, wherein the first delivery assembly may be fixed in a certain position, and aligned with a certain one of the plurality of container conveyors 111. When the first delivery assembly 12 moves in a direction close to the container conveyor 111, a preset number of external idle containers may be introduced into the container conveyor 111 to achieve an introduction supplement of the idle containers; when the first delivery assembly 12 moves in a direction away from the container conveyor 111, a to-be-replaced container filled with goods may be removed from the container conveyor 111 to achieve the output of a full loaded container. Thus, by changing the delivery directions of the first delivery assembly 12, introduction and output/removal of the container may be achieved with a set of components, saving more space.

Optionally, referring to FIG. 3, said sorting device further comprises a second delivery assembly 13;

said second delivery assembly 13 is aligned with one of said plurality of container conveyors 111, and a delivery direction of said second delivery assembly 13 is opposite to that of said first delivery assembly 12.

Specifically, as shown in FIG. 3, the aforementioned sorting device further comprises a second delivery assembly 13, wherein the second delivery assembly 13 is aligned with one of the plurality of container carriers 111, and the container carrier 111 aligned with may be identical to or different from the container conveyor 111 aligned with the first delivery assembly 12. The second delivery assembly 13 has a delivery direction opposite to that of the first delivery assembly 12, and when the first delivery assembly 12 is used for introducing idle containers, the second delivery assembly 13 may be used for removing/outputting a full loaded container; when the first delivery assembly 12 is used for removing/outputting the full loaded container, the first delivery assembly 13 may be used for introducing the idle containers. The two delivery assemblies are used for introduction and removal of the container respectively, and can operate independently at the same time, facilitating improving of the container replacement efficiency.

Optionally, referring to FIGS. 4 and 8, said sorting device further comprises a plurality of first sliding chutes 14 and a plurality of second sliding chutes 15, wherein the number of said first sliding chutes 14 and the number of said second sliding chutes 15 are each identical to that of said container conveyor 111;

said first sliding chutes 14 and said second sliding chutes 15 are both fixedly connected to the container delivering apparatus 11;

said first sliding chute 14 is aligned with the first discharge port 1011, and said second sliding chute 15 is aligned with said second discharge port 1012.

Specifically, as shown in FIGS. 4 and 8, in order to guide the sorting and feeding processes of the goods, the aforementioned sorting device also comprises a plurality of first sliding chutes 14 and a plurality of second sliding chutes 15, wherein the first sliding chutes 14 and the second sliding chutes 15 each have a number identical to that of said container conveyor 111, and the first sliding chutes 14 and the second sliding chutes 15 are both fixedly connected to the container delivering apparatus 11. The first sliding chute 14 is aligned with the first discharge port 1011, and when the goods are delivered out from the first discharge port 1011, the first sliding chute 14 may guide the goods delivered out from the first discharge port 1011 to accurately fall into a designated container. The second sliding chute 15 may guide the goods delivered out from the second discharge port 1012 to accurately fall into another designated container. With guiding effect of the two sliding chutes, it may help to ensure the accuracy of sorting and delivering goods.

Optionally, one end of said first sliding chute 14 adjacent to said first discharge port 1011 has a width not less than that of said first discharge port 1011, and the other end of said first sliding chute 14 has a width not greater than that of said container;

one end of said second sliding chute 15 adjacent to said second discharge port 1012 has a width not less than that of said second discharge port 1012, and the other end of said second sliding chute 15 has a width not greater than that of said container.

Specifically, to prevent goods from getting stuck in the gap between the sliding chute and the discharge port or the gap between the sliding chute and the container, for the first sliding chute 14, since the one end of the first sliding chute 14 adjacent to the first discharge port 1011 has a width not less than that of the first discharge port 1011, the goods may slide into the first sliding chute 14 without hindrance from the narrower first discharge port 1011, and since the other end of the first sliding chute 14 has a width not greater than that of the container, the goods may slide into the container without hindrance from the narrower first sliding chute 14.

For the second sliding chute 15, since the one end of the second sliding chute 15 adjacent to the second discharge port 1012 has a width not less than that of the second discharge port 1012, the goods may slide into the second sliding chute 15 without hindrance from the narrower second discharge port 1012, and since the other end of the second sliding chute 15 has a width not greater than that of the container, the goods may slide into the container without hindrance from the narrower second sliding chute 15.

Optionally, referring to FIG. 2, said sorting device further comprises at least one feeding apparatus 16;

said feeding apparatus 16 comprises a feed delivering assembly 161 and an information reading assembly 162, wherein the feed delivering assembly 161 is provided on one side of said sorting apparatus 10 and used to deliver goods to a sorting station 101 of said plurality of sorting stations 101 aligned with said feed delivering assembly 161, and said information reading assembly 162 is provided in a delivery path of said feed delivering assembly 161.

Specifically, as shown in FIG. 2, to achieve automatic feeding of the goods, the aforementioned sorting device also comprises a feeding apparatus 16, wherein the feeding apparatus 16 comprises a feed delivering assembly 161 and an information reading assembly 162, wherein the feed delivering assembly 161 is provided on one side (e. g., left side or right side of the forward direction of an open assembly line, inner side or outer side of a closed rotary assembly line) of the sorting apparatus 10 and used for delivering goods to a sorting station, aligned with the feed delivering assembly 161, of the plurality of sorting stations 101, and the information reading assembly 162 is provided in a delivery path of the feed delivering assembly 161. The feed delivering assembly 161 may be any one of a conveying belt without a partition plate, a conveying belt with partition plates, and a conveying roller. The information reading assembly 162 may be a scanning gun for reading barcode information or a camera with intelligent image recognition function. When the goods pass by the information reading assembly 162, the information reading assembly 162 can obtain information such as information of the list to which the goods belong, the destination of the goods, and the information of the goods themselves (such as size, name of the goods, category of goods, etc.). The goods are delivered to designated sorting station(s) of the plurality of sorting stations 101 through the feed delivering assembly 161, wherein the designated sorting station(s) is/are the sorting station(s) designated for the goods based on a sorting rule.

Optionally, said feeding apparatuses 16 is in a number of two, and the respective feed delivering assemblies of said two feeding apparatuses 16 are respectively aligned with two designated sorting stations of the plurality of sorting stations 101.

Specifically, in order to improve the feeding efficiency, two feeding apparatuses 16 can be provided in the aforementioned sorting device, then the respective feed delivering assemblies of the two feeding apparatuses 16 are respectively aligned with two designated sorting stations of the plurality of sorting stations 101, e.g., a first feeding apparatus is aligned with a first sorting station, and a second feeding apparatus is aligned with a second sorting station. The two feeding apparatuses can operate independently, and perform feeding for the sorting stations at the same time.

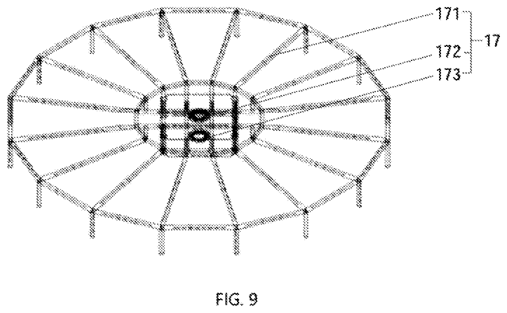

Optionally, referring to FIG. 9, said sorting device further comprises a bearing bracket 17;

said sorting apparatus 16 is movably connected to said bearing bracket 17, and said container delivering apparatus 11 is movably connected to said bearing bracket 17.

Specifically, as shown in FIG. 9, in order to simplify the assembly complexity of the whole sorting device, the rotation of the sorting apparatus 16 can be realized through the movable connection between the sorting apparatus 16 and the bearing bracket 17, and the rotation of the container delivering apparatus 11 can be realized through the movable connection between the container delivering apparatus 11 and the bearing bracket 17.

Specifically, when the sorting apparatus 16 is in a circular rotary cycle structure, the sorting apparatus 16 is articulated with the bearing bracket 17, and the container delivering apparatus 11 is articulated with the bearing bracket 17. It is understood that the structure of the sorting apparatus 16 may also be a rotary structure of other shapes such as a rectangular shape, and then the sorting apparatus 16 may be in slidable or rolling connection with the bearing bracket 17, and accordingly, the container delivering apparatus 11 may also be in slidable or rolling connection with the bearing bracket 17.

Optionally, referring to FIG. 9, said bearing bracket 17 comprises support brackets 171, a first rotary bearing 172, and a second rotary bearing 173;

the sorting apparatus 10 is articulated with the support brackets 171 through the first rotary bearing 171, and the container delivering apparatus 11 is articulated with the support brackets 171 through the second rotary bearing 172.

Specifically, as shown in FIG. 9, in order to reduce the rotary resistance and improve rotational smoothness, the bearing bracket 17 may comprise support brackets 171, a first rotary bearing 172, and a second rotary bearing 173.

The sorting apparatus 10 is articulated with the support brackets 171 through the first rotary bearing 171, and the container delivering apparatus 11 is articulated with the support brackets 171 through the second rotary bearing 172, which is thus helpful to improve the rotary efficiency of the sorting apparatus 10 and the container delivering apparatus 11 and facilitating the sorting efficiency.

In order to improve the safety of the above device and avoid contaminants from entering into the exposed parts, a main cover plate can be used to block a local area defined by the individual sorting stations along the rotary path. It is understood that in order to avoid interference, there is no need for the maximum size of the main cover plate to reach the discharge port near the rotary center. Similarly, a sorting cover plate can also be used to block a hollow area between each two adjacent sorting stations.

It is understood that in the description of the above embodiment, in order to realize the movement of each assembly or mechanism, the power source can be selected as an AC motor or a stepping motor according to actual needs. Of course, the power source of the linear reciprocating motion assembly may also be a telescopic cylinder, etc., which is not described repeatedly in the embodiment of the present invention.

The various embodiments in this specification are described in a progressive manner, and each embodiment focuses on the differences from other embodiments, and the same or similar parts between the various embodiments can be referred to each other.

It is easy for those skilled in the art to think that: any combination application of the above-mentioned various embodiments is feasible, so any combination of the above-mentioned various embodiments is the embodiment of the present disclosure, but the present specification will not detail those herein one by one due to length limit.

In the specification provided herein, a lot of specific details are explained. However, it can be understood that the embodiments of the present disclosure can be practiced without these specific details. In some instances, well-known methods, structures and technologies are not shown in detail, so as not to obscure the understanding of this specification.

Similarly, it should be understood that in order to simplify the present disclosure and help understanding one or more of the various aspects of the embodiments of the present disclosure, in the above description of the exemplary embodiments of the present disclosure, the various features of the present disclosure are sometimes grouped together into a single embodiment, figure, or description thereof. However, the disclosed method should not be interpreted as reflecting the intention that the claimed disclosure requires more features than those explicitly stated in each claim. More precisely, as reflected in the claims, the aspect of the present invention lies in that it is possible to use features less than all the features of a single embodiment disclosed above. Therefore, the claims following the specific embodiment are thus explicitly incorporated into the specific embodiment, wherein each claim itself serves as a separate embodiment of the present disclosure.

Those skilled in the art can understand that it is possible to adaptively change the modules in the device in the embodiment and set them in one or more devices different from the embodiment. The modules or units or components in the embodiments can be combined into one module or unit or component, and in addition, they can be divided into multiple sub-modules or sub-units or sub-components. Except that at least some of such features and/or processes or units are mutually exclusive, any combination can be used to combine all the features disclosed in this specification (comprising the accompanying claims, abstract and drawings) and all processes or units of any method or device disclosed in this way. Unless expressly stated otherwise, each feature disclosed in this specification (comprising the accompanying claims, abstract and drawings) may be replaced by an alternative feature providing the same, equivalent or similar purpose.

In addition, those skilled in the art can understand that although some embodiments described herein comprise certain features comprised in other embodiments but not other features, the combination of features of different embodiments means to be within the scope of the present disclosure and form different embodiments. For example, in the claims, any one of the claimed embodiments can be used in any combination.

It should be noted that the above-mentioned embodiments illustrate the present disclosure, rather than limiting the present disclosure and those skilled in the art can design alternative embodiments without departing from the scope of the appended claims. In the claims, any reference numerals placed between parentheses should not be constructed as a limitation to the claims. The word “comprising” does not exclude the presence of elements or steps not listed in the claims. The word “a” or “an” preceding an element does not exclude the presence of multiple such elements. The present disclosure can be realized by means of hardware comprising several different elements and by means of a suitably programmed computer. In the unit claims enumerating several devices, several of these devices may be embodied in the same hardware item. The use of the words first, second, and third, etc. do not indicate any order. These words can be interpreted as names.

1. A sorting device comprising a sorting apparatus configured for moving along a predetermined path and a container delivering apparatus located beneath said sorting apparatus;
said sorting apparatus comprises a plurality of sorting stations that are provided along said predetermined path, wherein each sorting station is provided with a first discharge port and a second discharge port at two sides of said predetermined path respectively;
a plurality of containers are placed on said container delivering apparatus , with the plurality of containers arranged in a linear array, wherein a direction of said linear array is a direction of a connecting line of said first discharge port and said second discharge port, and the plurality of containers on said container delivering apparatus are configured to reciprocate in the direction of the connecting line of said first discharge port and said second discharge port, such that two of said plurality of containers are aligned with said first discharge port and said second discharge port.

2. The sorting device according to claim 1, wherein said sorting apparatus is in an open linear structure or a closed rotary cycle structure.

3. The sorting device according to claim 2, wherein said container delivering apparatus comprises a plurality of container conveyors and a rotary mechanism;
said container conveyors are fixedly connected to said rotary mechanism; and
said plurality of containers are placed on said container conveyors, and the rotary mechanism is configured to drive the container conveyors to rotate.

4. The sorting device according to claim 3, wherein each of said container conveyors comprises a reciprocating delivery mechanism and a container carry platform; and
the plurality of containers is placed on said container carry platform, the reciprocating delivery mechanism is fixedly connected to said rotary mechanism, and said container carry platform is configured to linearly reciprocate with said reciprocating delivery mechanism.

5. The sorting device according to claim 4, wherein said rotary mechanism comprises a rotating chassis and universal wheels; and
said container conveyors are fixed to one side of said rotating chassis away from the ground, and said universal wheels are fixed to one side of said rotating chassis close to the ground.

6. The sorting device according to claim 3, wherein said rotary mechanism comprises a circular rail; and
a bottom of each of said container conveyors is slidably connected to said circular rail.

7. The sorting device according to claim 1, wherein each sorting station is provided thereon with a sorting-delivering assembly configure for moving towards said first discharge port or said second discharge port.

8. The sorting device according to claim 7, wherein said sorting-delivering assembly is any one of a conveying belt without a partition plate, a conveying belt with partition plates, a conveying roller, a tilting tray and a tilting bucket.

9. The sorting device according to claim 1, wherein said each sorting station is provided thereon with side baffles which are located between said first discharge port and said second discharge port, and provided along two sides of a discharge direction.

10. The sorting device according to claim 3, wherein said sorting device further comprises a first delivery assembly; and
said first delivery assembly is aligned with one of said plurality of container conveyors, and the first delivery assembly is configured to move in a direction close to or away from said container conveyor, for introducing a preset number of idle containers into said container conveyors, and/or removing at least one to-be-replaced container from said container conveyors.

11. The sorting device according to claim 10, wherein said sorting device further comprises a second delivery assembly; and
said second delivery assembly is aligned with one of said plurality of container conveyors, and a delivery direction of said second delivery assembly is opposite to that of said first delivery assembly.

12. The sorting device according to claim 1, wherein said sorting device further comprises a plurality of first sliding chutes and a plurality of second sliding chutes, wherein number of said first sliding chutes and number of said second sliding chutes are both identical to that of said container conveyors;
said first sliding chutes and said second sliding chutes are all fixedly connected to the container delivering apparatus; and
each first sliding chute is aligned with a corresponding first discharge port, and each second sliding chute is aligned with a corresponding second discharge port.

13. The sorting device according to claim 12, wherein one end of the each first sliding chute adjacent to said corresponding first discharge port has a width not less than that of said corresponding first discharge port, and the other end of the each first sliding chute has a width not greater than that of a corresponding container; and
one end of the each second sliding chute adjacent to said corresponding second discharge port has a width not less than that of said corresponding second discharge port, and the other end of the each second sliding chute has a width not greater than that of a corresponding container.

14. The sorting device according to claim 1, wherein said sorting device further comprises at least one feeding apparatus;
the at least one feeding apparatus comprises a feed delivering assembly and an information reading assembly, the feed delivering assembly is provided on one side of said sorting apparatus and configured to deliver goods to a sorting station of said plurality of sorting stations aligned with said feed delivering assembly, and said information reading assembly is provided in a delivery path of said feed delivering assembly.

15. The sorting device according to claim 14, wherein said at least one feed delivering assembly is in a number of two.

16. The sorting device according to claim 1, wherein said sorting device further comprises a bearing bracket; and
said sorting apparatus is movably connected to said bearing bracket, and said container delivering apparatus is movably connected to said bearing bracket.

17. The sorting device according to claim 16, wherein said sorting apparatus is in a circular rotary cycle structure, said sorting apparatus is articulated with said bearing bracket, and said container delivering apparatus is articulated with said bearing bracket.

18. The sorting device according to claim 17, wherein said bearing bracket comprises support brackets, a first rotary bearing, and a second rotary bearing; and
said sorting apparatus is articulated with said support brackets through said first rotary bearing, and said container delivering apparatus is articulated with said support brackets through said second rotary bearing.

19. The sorting device according to claim 4, wherein a surface of said container carry platform, on which the plurality of containers are placed, is provided with a plurality of limiting elements configured for limiting translation of said containers in a first direction and/or a second direction, wherein said first direction is a moving direction of said container carry platform, and the second direction is perpendicular to said first direction.

20. The sorting device according to claim 3, wherein said rotary mechanism comprises a rotating chassis and universal wheels; and
said container conveyors are fixed to one side of said rotating chassis away from the ground, and said universal wheels are fixed to one side of said rotating chassis close to the ground.
